(19) United States
(12) Patent Application Publication
(10) Pub. No.: US 2010/0082162 A1
(43) Pub. Date: Apr. 1, 2010

(54) AIR CONDITIONING SYSTEM AND METHOD OF CONTROL

(75) Inventors: Kevin Brian Mundy, Kellyville (AU); Jian Xiang Yu, Milperra (AU)

Correspondence Address: Weaver Austin Villeneuve & Sampson LLP, P.O. BOX 70250, OAKLAND, CA, 94612-0250, US

(73) Assignee: Actron Air Pty Limited

(21) Appl. No.: 12/240,588

(22) Filed: Sep. 29, 2008

(51) Int. Cl. G05B 15/00; F25D 23/00; F25B 1/00

(52) U.S. Cl. 700/277; 62/259.1; 62/228.5

(57) ABSTRACT

An air conditioning system and control method to allow individual zone thermostats to directly control a variable capacity compressor and adaptively adjust the indoor supply air volume to meet zoning demands, without using static pressure or flow sensors or entering a set of pre-defined air flow values for each zone into a controller. The method controls an air conditioning system that is able to receive signals or commands from individual zone thermostats and give priority to a highest demand zone/thermostat. For example, a priority thermostat can be used to directly control the variable capacity compressor via an indoor controller and outdoor controller.

### TECHNICAL FIELD

The present invention generally relates to ducted air conditioning systems, and in particular to an air conditioning system having a plurality of zones and/or a method of control or operation of an air conditioning system.

### BACKGROUND

Reference to an air conditioning system should be understood to include reference to an air conditioner, a heat pump system and/or a heat pump. As an illustrative example, a heat pump can be considered to be a reverse cycle air conditioner, that is, a type of air conditioning system. It should be noted that reference to ‘outdoor unit’ need not necessarily require the unit to be physically located completely external to a home or building, rather the unit need only be separated from the air conditioned areas/zones.

Presently there exists a major focus on the energy consumed by air conditioning systems and the need for highly energy efficient systems is more important than ever before. There is a need to allow energy consumed by ducted air conditioning systems to be dramatically lowered compared to current systems available on the market today. Users, owners and operators of ducted air conditioning systems desire to be able to control the temperature of each zone (for example a room or office) and to be able to turn on or off any zone they desire, no matter how large or small, to help reduce energy usage and reduce running costs. However, being able to turn any zone on or off is desired to be achieved without sacrificing comfort in other zones or wasting energy by air conditioning unoccupied areas. So in essence, consumers typically want a ducted air conditioning system that can air condition an entire home or office area, but also be able to air condition only a small room/zone or office. Currently, this has not been possible with typical ducted air conditioning systems.

Presently known conventional ducted air conditioning systems need to have major components all matching in capacity whenever the system is operating. This requires that the compressor capacity has to match the maximum thermal load of the space to be conditioned, the outdoor and indoor heat exchangers have to match the compressors performance, the indoor fan has to have a corresponding amount of airflow over the indoor heat exchanger, and the number of zones and outlets need to have corresponding airflow characteristics. Furthermore, the compressor only has ON and OFF operation modes, so has to cycle on with 100% capacity when cooling or heating is required, and cycle completely off with 0% capacity when the air conditioned space target temperature is reached. This type of cycling system can cause large temperature and humidity swings, and also large changes in noise levels in the air conditioned space, when the thermal load is below the maximum design conditions.

A conventional indoor unit typically contains a heat exchanger (i.e. coil), a fan motor and a blower, and sometimes a control module. The typical indoor unit delivers a relatively constant airflow to the contained space when the ductwork remains constant. Whether the system has zones or no zones, a standard Permanent Split Capacitor (PSC) Alternating Current (AC) induction fan motor operates by delivering an airflow quantity equal to the system profile and fan curve intersection points. Some systems offer a small range of speeds, so the operator can select between high airflow and a slightly reduced airflow when maximum capacity is not required or quieter operation is required. The motor speed is typically limited by the motor design. Typically, the airflow would only change about 10 to 15% depending on the static pressure in the ductwork.

Zoning the air conditioned space into separate zones (typically 2 to 8 zones) that can be manually turned on or off, has now become a popular method to offer energy savings; but only offers limited improvement in reducing temperature swings in the conditioned space. For example, temperature swings sometimes can be made worse as too much refrigerating and airflow capacity is directed into a smaller air conditioned space. This is because the compressor still only operates at a single level of 100% and the indoor fan cannot adjust its airflow rate low enough, so the operator would usually resort to opening outlets at all the zones to regain comfort at the expense of more energy use.

With conventional systems, an operator must be very careful when adding zones to the ducting system, as closing off too many zones by the operator increases the static pressure in the duct work. It is known that an increase in static pressure on an indoor fan causes a lower total airflow volume and this effects the thermal load on the heat exchanger/compressor combination, which can cause the system to malfunction. This is similar to a heat exchanger freeze-up in a cooling operation or refrigerant over-pressure in a heating operation.

One known way to allow the operator to make more use of zoning and to attempt to save energy and also improve comfort is by adding a Variable Air Volume (VAV) zone system. A typical VAV system has individual thermostats controlling the zone dampers and providing cooling or heating calls to a main controller. A VAV system may also include a bypass damper between the supply and return air ducts. This type of system overcomes the previously mentioned problem of too many zones closing and the airflow being reduced over the indoor heat exchanger. By adding a bypass duct installed between the return air and supply air ducts, the airflow can be kept more constant over the indoor heat exchanger. In this type of design, the bypass damper is controlled by how much static pressure is present in the supply duct, so when zones are closing, the static pressure of the installed duct work will increase and open the bypass damper. This allows the fan to keep forcing a relatively constant air volume over the indoor heat exchanger and not blowing too much air into the zones that are still on.

One problem with this type of system/method is when the bypass damper opens then the heated or cooled supply air enters the bypass damper. The supply air is then passed into the return air, where it mixes with the return air from the conditioned space, sometimes making the air at the indoor heat exchanger too cold for a cooling mode, and too hot for a heating mode. This type of system typically attempts to monitor this by having a temperature sensor that is either measuring the air passed onto the indoor heat exchanger or the air coming off the indoor heat exchanger. Then, if these temperatures fall outside predefined safety limits, the compressor is shut down. This method is an improvement over a non-zoned system, but still does not provide optimal comfort or efficiency.

Indoor fan motor technologies have been developed that keep a constant volume of air over the heat exchanger. So when a zone is closed, the fan will sense the change in static pressure and increase power to the motor, thus keeping a relatively constant volume of total airflow. This operation can be reversed when zones are opened. However, this arrangement does not always satisfy a user. As more zones are turned off, the total airflow rate will remain the same; so the excess pre-conditioned airflow will now recycle through the bypass damper and duct, thus sometimes making the air passing onto the indoor heat exchanger either too cold or too hot.

There are also known systems with two stage compressors that give two capacity steps. Step one would 100% and step two normally would be between 50% and 70%. This gives better temperature control, but is still limited to only two compressor capacity settings that cannot always match the required thermal load of multiple zone demands.

Another type of ducted system is provided with an inverter controlled compressor in the outdoor unit. These inverter controlled compressor systems offer more capacity steps than a two-stage compressor, but none of these types of system provide for any sort of integrated VAV zoning that can interact with the outdoor compressor unit.

There is a need for an air conditioning system and method of operation or control which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

According to a first aspect, there is provided a method of controlling or operating an air conditioning system where signals, data or commands are received from individual zone thermostats and a priority is provided to a highest demand zone/thermostat. For example, the priority thermostat can be used to control a variable capacity compressor. Control can be direct and via an indoor controller and outdoor controller as typically the variable capacity compressor is part of an outdoor unit.

It should be appreciated that reference to an indoor unit (or components thereof) and an outdoor unit (or components thereof), does not necessarily require physically separated or distinct units (or components thereof). The indoor unit and the outdoor unit may, in certain embodiments, be provided as a single or integrated unit.

According to a second aspect, there is provided a method of controlling an air conditioning system, the air conditioning system including a plurality of individual zone thermostats, an outdoor unit including a variable capacity compressor, and at least one controller, the method including the steps of: receiving, at the at least one controller, signals from the plurality of individual zone thermostats; determining a heating or cooling demand based on the signals; and, using the determined demand to control operation of the variable capacity compressor.

According to a third aspect, there is provided an air conditioning system for supplying conditioned air to a plurality of zones, each zone provided with an individual zone thermostat, each zone also provided with a zone damper, the system including at least one controller able to communicate with the individual zone thermostats and able to control operation of the zone dampers.

According to a particular example aspect, there is provided a method for controlling residential or commercial air conditioning systems. For example, the method can be utilised in the control of a ducted air conditioning system that includes a compressor unit (also known as a condenser), an indoor unit (also known as an evaporator or indoor fan coil unit), zone dampers, and zone thermostats or sensors. In one form, the method analyses a plurality of individual zone thermostats and provides for control of an outdoor unit, for example including a variable capacity compressor, a multi-speed outdoor fan(s), and a reversing valve. Control of an indoor unit also can be provided, the indoor unit including, for example, a variable speed indoor fan (e.g. an electronically commutated (ECM) fan), an electronic expansion valve (EXV), and modulating zone dampers to improve comfort and reduce energy usage.

The method can be applied in residential and commercial air conditioning and/or heat pump systems having individual zone thermostats or temperature sensors. An air conditioning system is also provided that may include digital proportional feedback control from one or more zones, or variable duct work paths. In another form, an indoor unit can be provided that is installed in ducted/central heating/cooling/heat pump systems that have zones or variable duct work paths and require a fan that can deliver a variable volume of air to match a changing thermal and airflow load depending on how many zones are turned on or off. In yet another form, an outdoor unit can be provided that includes a variable capacity refrigeration compressor that can also adapt to the changing thermal load.

In a particular example form, there is provided an air conditioning system, and method of control thereof, in which selected components have variable capacity control, speed control or modulation control. This allows the air conditioning system to air condition an entire house or office area, or air condition only a small room/zone or office, without recycling air through a bypass damper, or dumping conditioned air in unoccupied zones. This also eliminates any need for multiple separate systems to be installed.

In a particular form, the method/system can directly and proportionally control a variable capacity compressor resulting from sensing performed at any of the individual zone thermostats. An indoor fan speed can be automatically slowed when any zone is closed, and increased when any zone is opened. For example, the system can operate between about 10% and 100% of full load thermal capacity.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 (prior art) illustrates a conventional residential/commercial ducted air conditioning system.

FIG. 2 (prior art) illustrates a conventional system with a third party VAV system using a standard Permanent Split Capacitor (PSC) AC induction fan motor and requiring a bypass duct and dampers.

FIG. 3 (prior art) illustrates a two-stage compressor system with a variable speed indoor fan that offers constant airflow control and requiring a bypass duct and dampers.

FIG. 4 (prior art) illustrates a variable speed compressor, also known as an inverter controlled compressor system. This system uses a standard Permanent Split Capacitor (PSC) AC induction fan motor.

FIG. 5 illustrates an example improved air conditioning system.

FIG. 6 illustrates a flow diagram of an example cooling or heating mode selection process.

FIG. 7 illustrates a flow diagram of an example method of a compressor capacity control process.

FIG. 8 illustrates a flow diagram of an example method of system control.

### PREFERRED EMBODIMENTS

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

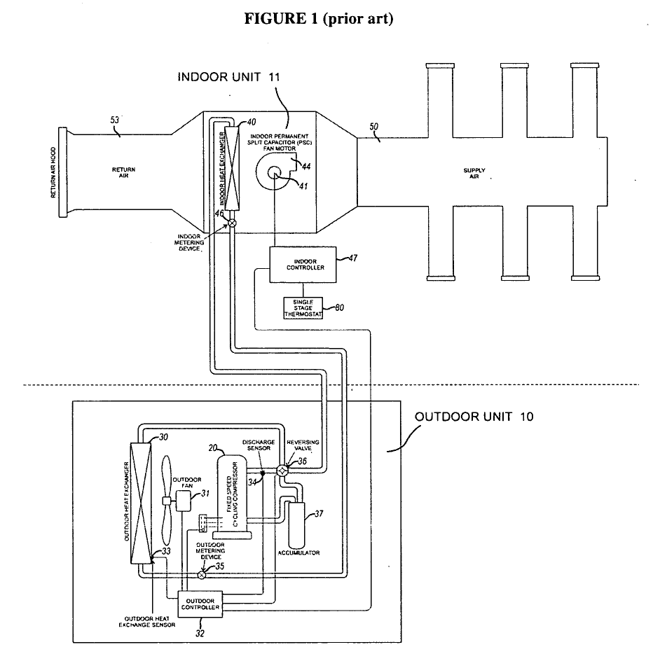

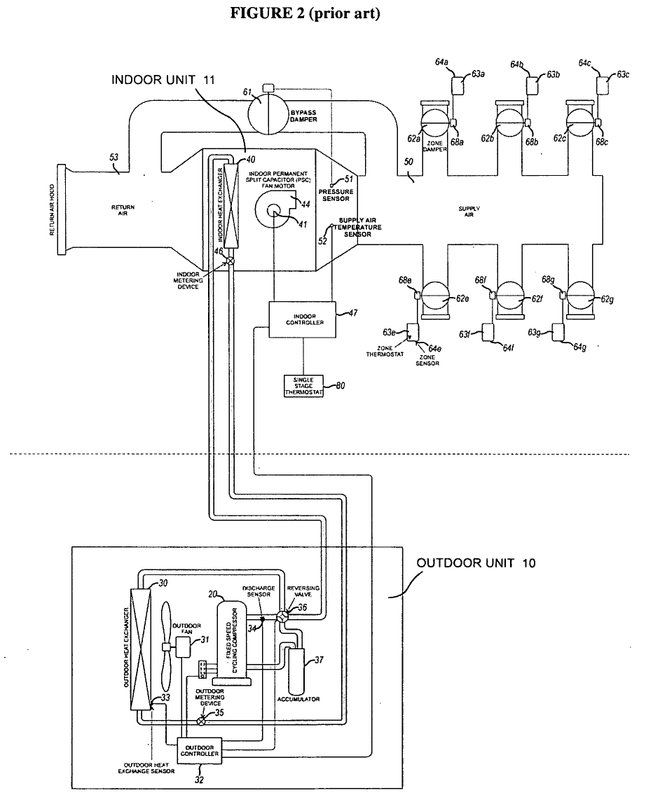

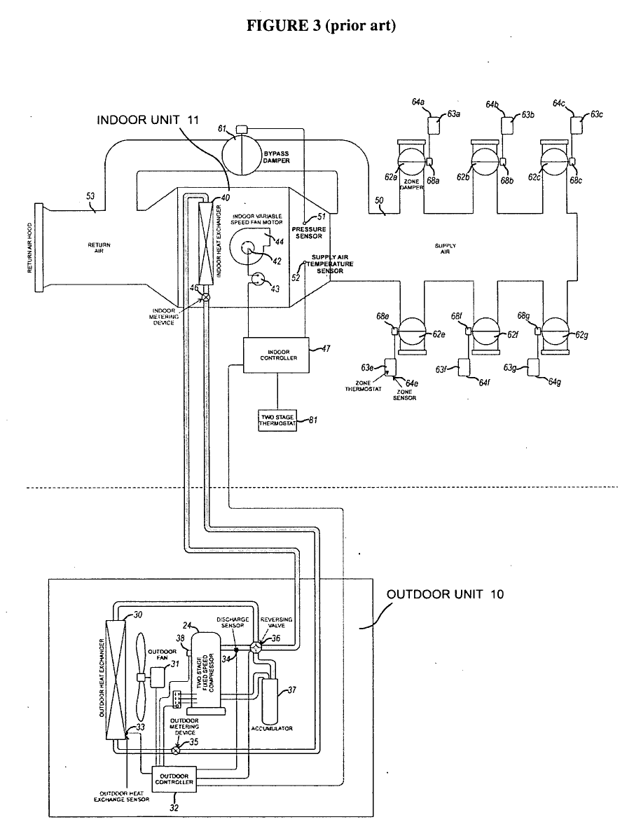

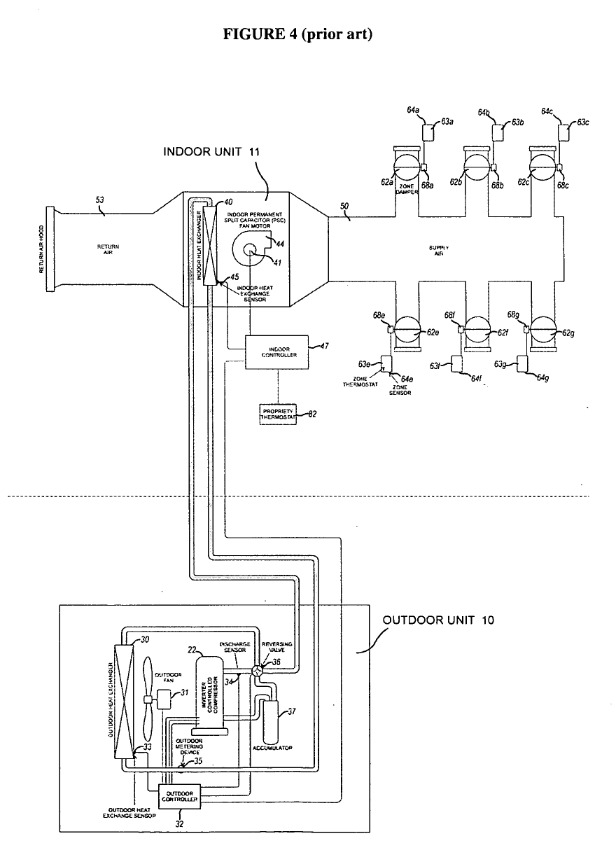

Referring to FIGS. 1 to 4, there are illustrated known air conditioning systems. FIG. 1 shows a conventional residential or commercial ducted air conditioning system. FIG. 2 shows a conventional air conditioning system with a third party VAV system using a standard Permanent Split Capacitor (PSC) AC induction fan motor and a bypass duct and damper. FIG. 3 shows a two-stage compressor system with a variable speed indoor fan that offers constant airflow control utilising a bypass duct and damper. FIG. 4 shows a variable speed compressor, also known as an inverter controlled compressor system. This type of system uses a standard PSC AC induction fan motor.

The different types of air conditioning systems illustrated in FIGS. 1 to 4 have some common features, and variously include an outdoor unit 10, an indoor unit 11, a fixed speed cycling compressor 20, an inverter controlled compressor 22, and a two stage fixed speed compressor 24. The outdoor unit 10 variously includes an outdoor heat exchanger 30, an outdoor fan 31, an outdoor controller 32, an outdoor heat exchange sensor 33, a compressor discharge sensor 34, an outdoor metering device 35, and an outdoor reversing valve 36, an outdoor accumulator 37. The indoor unit 11 variously includes an indoor heat exchanger 40, an indoor Permanent split Capacitor (PSC) fan motor 41, an indoor variable speed fan motor 42, an indoor fan motor controller constant airflow 43, an indoor fan blower 44, an indoor heat exchange inlet sensor 45, an indoor metering device 46, and an indoor controller 47.

The different types of air conditioning systems illustrated in FIGS. 1 to 4 also variously include a supply air duct 50, a supply air pressure sensor 51, a supply air temperature sensor 52, a return air duct 53, a bypass damper 61, zone dampers 62, zone thermostats 63, zone sensors 64, zone motors 68, single stage thermostat 80, two stage thermostat 81 or a propriety thermostat 82.

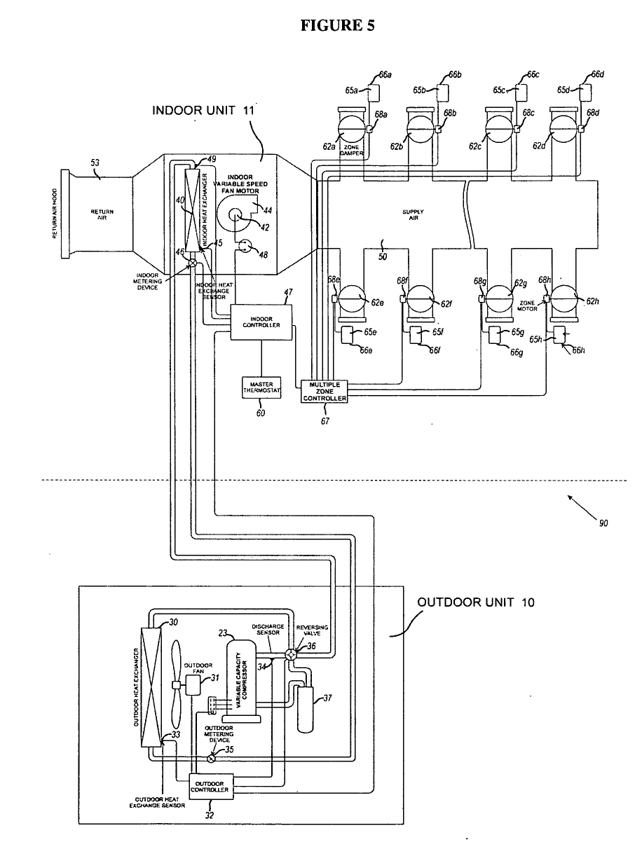

Referring to FIG. 5, there is illustrated an example improved air conditioning system 90 which includes an outdoor unit 10, a variable capacity compressor 23, a four way reversing valve 36, an outdoor heat exchanger 30, an outdoor metering device 35, an outdoor fan(s) 31, an outdoor accumulator 37, an outdoor heat exchanger sensor 33, an compressor discharge pipe sensor 34, and an outdoor controller 32. Also provided is an indoor unit 11 including an indoor metering device 46, an indoor heat exchanger 40, an indoor variable speed motor 42, a variable speed motor controller 48, an indoor fan blower 44, a master wall controller 60, a return air duct 53, a supply air duct 50, a multiple zone controller 67 to communicate with individual zone thermostats 65 (and/or individual zone sensors 66) and to control the modulated zone motors 68 and/or zone dampers 62.

Individual zone sensors 66 can be considered to be part of (or in some forms equivalent to) individual zone thermostats 65, for example if individual zone sensors 66 are temperature sensors. Alternatively or additionally, individual zone sensors 66 may be provided to perform some other sensing function, such as a humidity measurement.

In various forms, the multiple zone controller 67 and the indoor controller 47 can be integrated or provided as a single controller unit, as different component parts of a controller, or provided as distinct controllers. Reference to the at least one controller is a reference to the multiple zone controller 67 and/or the indoor controller 47. For example, the indoor controller 47 may be provided as part of an existing system and the multiple zone controller 67 provided as an additional controller.

The outdoor controller 32 controls the variable capacity compressor 23 based on a demand, signal, instruction, data or the like, from the indoor controller 47. The variable capacity compressor 23 is also periodically controlled from the outdoor controller 32 for defrost and from the compressor discharge sensor 34. Outdoor fan 31 is speed based on outdoor heat exchange sensor 33 measured temperatures and discharge sensor 34 temperatures. A reversing valve 36 is based on heating or cooling demand from indoor controller 47.

The indoor controller 47 controls the indoor metering device 46 based on the indoor heat exchange inlet sensor 45 and indoor heat exchange outlet sensor 49 measurements. Indoor controller 47 controls the indoor blower 44 via its associated variable speed motor 42 and motor controller 48 by using a self-learned profile, without using a supply duct work static pressure sensor (e.g. pressure sensor 51 from FIG. 3). The indoor controller 47, as the master of air conditioning system 90, communicates directly with the outdoor controller 32 and multiple zone controller 67.

Although control of eight zones, areas or spaces are illustrated in FIG. 5, it should be appreciated that any number of zones, areas or spaces can be provided for by the air conditioning system 90 and the method of control thereof.

In another embodiment, the indoor unit and the outdoor unit can be provided as an integrated unit. For example, the indoor unit and the outdoor unit could be a single ‘roof unit’, where a roof provides a barrier between an indoor air conditioned region and an external region.

### Heat/Cool Mode Selection

When the air conditioning system 90 is turned on, the multiple zone controller 67 (or the indoor controller 47) receives data or signals from all active individual zone thermostats 65 and calculates each active zone's cooling demand and heating demand as follows:

1) Cooling Demand and Heating Demand:
We define the cooling demand (CD) and heating demand (HD) as follows:

CD=sum(dTi) if dTi>0 (1)

HD=sum(dTi) if dTi<0 (2)

where,
dTi=Ti−Tiset;
i=1,2, . . . ,n active zone;
n=maximum number of zones in the system;
Ti=zone temperature of i-th active zone;
Tiset=set temperature of i-th active zone;

We conclude as follows:

a) The air conditioning system will run in “Cooling” mode if CD>HD;

b) The air conditioning system will run in “Heating” mode if CD<HD;

c) Then go to 2) below if CD=HD;

2) Highest Demand Zone:
When the air conditioning system has an equal cooling demand and heating demand, then the highest demand zone has priority. We define the highest demand signal as follows:

dTmax=max{dT1, dT2, . . . , dTn} (3)

We conclude as follows:

a) The air conditioning system will run in “Cooling” mode if dTmax>0;

b) The air conditioning system will run in “Heating” mode if dTmax<0;

c) Then go to 3) below if cooling dTmax=heating dTmax;

3) Most Zone Demand:
When the air conditioning system has equal cooling highest demand and heating highest demand, the highest number of zones that require the same mode will have priority. We can define the total number of cooling demand zones (CN) and the total number of heating demand zones (HN) as follows:

CN=num{Cooling Demand Zones} (4)

HN=num{Heating Demand Zones} (5)

We conclude as follows:

a) The air conditioning system will run in “Cooling” mode if CN>HN;

b) The air conditioning system will run in “Heating” mode if CN<HN;

c) The air conditioning system will run in “Cooling” mode as default, if CN=HN.

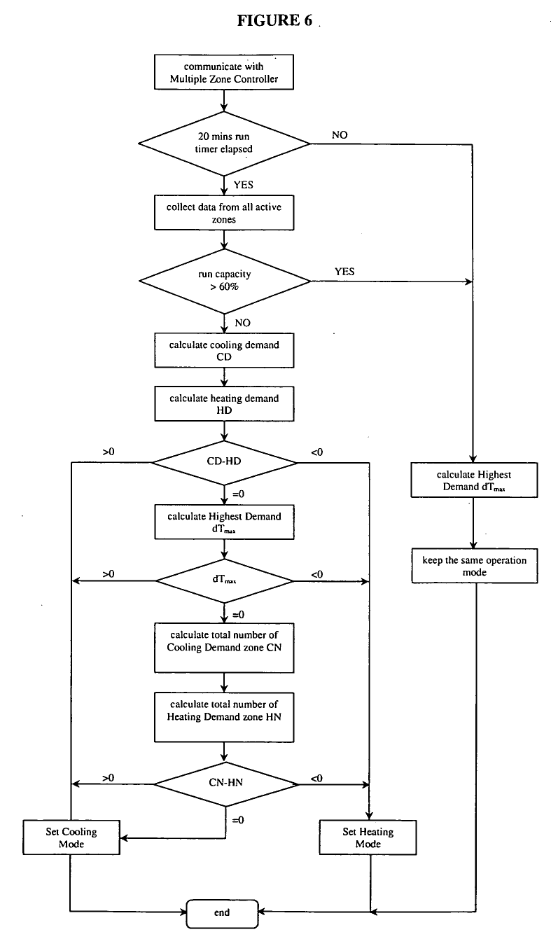

Referring to FIG. 6 there is illustrated a flow diagram of an example method of mode selection. This heat mode or cool mode selection method can be used for, but is not limited to, controlling a condenser associated with an indoor unit 11 controlling multiple zones, for example any of the air conditioning systems illustrated in FIG. 2, 3, 4 or 5.

In another embodiment, a method is provided that can be used for controlling a multi-head air conditioning system having more than one indoor unit. Using each indoor unit's cooling or heating demand, instead of each zone's demand, the same principle can be used to determine the operation mode within each of multiple indoor units. In this case, an indoor metering device 46, such as an electronic expansion valve (EXV), would be used to control the temperature of the conditioned space, instead of the zone damper 62.

### Capacity Control

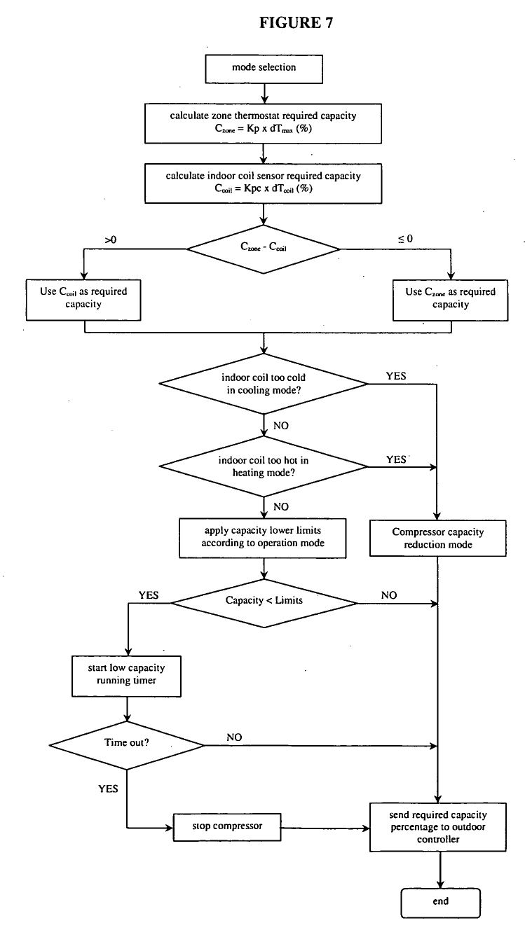

Referring to FIG. 7 there is illustrated a flow diagram of an example method of capacity control. Once the indoor controller 47 has determined whether a heating mode or a cooling mode is required, the indoor controller 47 forwards, relays or provides a proportional signal from an individual zone thermostat 65 with the largest differential in the selected mode to the outdoor controller 32. Then the outdoor controller 32 provides a capacity control signal, as a pulse width modulation (PWM) signal waveform, to the variable capacity compressor 23 located in or as part of the outdoor unit 10.

Whenever another individual zone thermostat 65 that requires the same operation mode has a greater differential, it will take over priority and control the variable capacity compressor 23 directly via indoor controller 47 and outdoor controller 32. The required capacity of the variable capacity compressor 23 is calculated as follows:

Czone(%)=Kp*dTmax (6)

where,

Kp=proportional constant.

Preferably, though not necessarily, the default value of Kp is 25.0%/° C. Every 30 seconds, for example, the indoor controller 47 reviews the status of individual zone thermostats 65 and re-calculates the required capacity for the variable capacity compressor 23 to run.

Every 20 minutes during operation, for example, the air conditioning system 90 can look to see whether cooling or heating is required. This 20 minute period is adjustable via the master thermostat 60. If the variable capacity compressor 23 is operating at greater than 60% capacity (this 60% is adjustable), the air conditioning system 90 remains in its current mode and does not change modes, even, for example, if an individual zone thermostat 65 is calling for a different mode.

### Capacity Control Priority

The indoor controller 47 monitors the indoor heat exchanger inlet sensor 45 and indoor heat exchanger outlet sensor 49. The temperature of the indoor heat exchanger 40 is ignored (i.e. no consequential action taken) unless the sensor temperature falls below a pre-defined value for cooling or rises above a pre-defined value for heating, that is outside an acceptable range that may be preset or determined.

If the temperature of the indoor heat exchanger 40 falls below the pre-defined value for cooling or rises above the pre-defined value for heating, the indoor controller 47 uses the indoor heat exchanger's temperature as compressor capacity control and the individual zone thermostats 65 no longer have priority. Priority is then a pre-defined heat exchanger target temperature for cooling or a pre-defined heat exchanger target temperature for heating. The pre-defined indoor heat exchanger temperature targets are adjustable by the user via the master thermostat 60 for both heating and cooling in small increments.

The indoor controller 47 then controls compressor capacity based on the lowest demand between the indoor heat exchanger temperature requirement and the largest differential individual zone thermostat 65 requirement.

We define indoor heat exchanger (coil) sensor required capacity as follows:

Ccoil(%)=Kpc*dTcoil (7)

where,
Kpc=proportional constant;
dTcoil=Tcoil−Ttarget;
Tcoil=indoor heat exchanger temperature;
Ttarget=indoor heat exchanger target temperature.
Then we use the lower measure between Czone and Ccoil as the final required capacity.

This capacity control priority method is shown in FIG. 7 and allows the variable capacity compressor 23 to be directly proportionally controlled via either the individual zone thermostats 65, or an indoor heat exchanger temperature derived from the indoor heat exchanger inlet sensor 45 and outlet sensor 49. This method improves on the most common method of controlling most types of compressors in variable air volume ducted systems, which relies on the supply air temperature sensor 52 as shown in FIG. 3. The system shown in FIG. 3 would control the two-stage fixed speed compressor 24 by staging the two-stage fixed speed compressor 24 between its two capacity steps depending on the measured supply air temperature.

By using the method shown in FIG. 7, the variable capacity compressor 23 can respond much faster. For example, when a hot zone is turned on and the system requires cooling, the variable capacity compressor 23 obtains the capacity demand directly from the individual zone thermostat 65 with the greatest differential. Other systems rely on the refrigeration system to respond with either an increase in suction temperature or supply air temperature measured from supply air sensor 52 that may take a few minutes.

### Automatic Efficiency Optimisation

Most variable capacity compressors 23 have an efficiency curve that greatly changes between highest capacity and lowest capacity. The Copeland™ digital scroll type of variable capacity compressor is found to have a high EER between 60% and 100%, moderate efficiency between 60% and 40% and lower efficiency from <39% to its minimum capacity 10%. This data may vary between different types of systems and compressors. In one particular, but non-limiting, example, the variable capacity compressor is a Copeland™ digital scroll condensing unit.

In another example, the control method can be used with a compressor that can be an inverter controlled compressor 22 (as illustrated in FIG. 4). The indoor controller 47 has a predefined capacity embedded in associated software that does not allow the variable capacity compressor 23 to run for more than a predetermined time. The inverter controlled compressor 22, when running below around 40%, has a lower EER. Thus, a timer will turn the variable capacity compressor 23 off after a pre-determined time. In a cooling only mode, the indoor controller 47 starts a pre-defined maximum run period timer as soon as the required capacity is below 50%, and also limits the variable capacity compressor 23 capacity to no lower than 40%. These mentioned values might change according to what type of variable capacity compressor 23 is used, or specific EER curves for an individual system. The same process can be applied to a heating only mode. When an automatic heat-cool mode is selected by an operator, it is believed that comfort is more important, so the variable capacity compressor 23 can operate at a lower capacity for an extended period, but is still limited by a run timer. The automatic mode allows for more comfort with tighter temperature control, but some efficiency expense.

### Automatic Comfort Optimisation

Keeping the variable capacity compressor 23 operating in its efficient capacity range is acceptable when conditioning a large area and indoor airflow is close to the nominal rate. However, this feature would limit the comfort level when only running a small zone and the indoor airflow is well below nominal airflow rate. The air conditioning system shown in FIG. 5 may be required to air condition only one relatively small zone on a regular basis. If the capacity was limited to running not lower than 40-50%, the zone (for example a room or office) would receive large temperature swings and normally the only way to solve this would be to turn another zone on, spreading the excess capacity to unoccupied areas. A better way is to allow the variable capacity compressor 23 to run in its inefficient operating capacity envelope, even if it is only required to run a small occupied zone, as this would still be more efficient than conditioning a larger unoccupied area.

### Reduced Capacity Mode

The automatic comfort optimisation works by cancelling the pre-defined maximum run period timer when the variable capacity compressor 23 is operating below a pre-defined capacity percentage. Thus, if the heat exchanger temperature is too cold in cooling mode or too hot in heating mode, the variable capacity compressor 23 goes into a reduced capacity mode. Whenever the variable capacity compressor 23 is in reduced capacity mode, it can run below 50% for as long as required. Even though the variable capacity compressor 23 is running at a less efficient operating point, it is still more economical than running more zones.

### Indoor Fan Control

The indoor controller 47 has an automatic control method of the indoor variable speed fan motor 42 speed being set by a self-learn mode and a fan profile curve made by associated software. When a user has selected the automatic mode at the master thermostat 60, the indoor variable speed fan motor 42 then maintains a relatively constant supply air static pressure, whilst the individual zone dampers 62 are modulating between opening and closing. By maintaining a relatively constant supply air static pressure, the outlets receive only a required airflow. When compared to a fixed speed or standard Permanent Split Capacitor (PSC) AC induction fan motor with limited speed control, as shown in FIG. 2, the power consumption of the variable speed fan 42 shown in FIG. 5 is greatly reduced, and there is no oversupply of excess air to any zones that are in an open position.

The indoor controller 47 senses a speed change in the indoor variable speed fan motor 42 if the multiple zone controller 67 modulates any of the zone dampers. The indoor controller 47, based on a self-learn fan profile curve, can speed up or slow down the indoor variable speed fan motor 42 according to the dampers 62 opening or closing respectively.

In a particular, but non-limiting, example system 90 uses an indoor variable speed fan motor 42 such as an ECM or EC fan. Because each indoor variable speed fan motor 42 and indoor fan blower 44 combination has its own operating profile, the indoor fan can be forced to run along a pre-defined curve called a profile. The pre-defined profile can be obtained by testing the indoor variable speed fan motor 42 and indoor fan blower 44 combination at a pre-defined installation. The self-learning mode can be initiated once the indoor unit 11 and all associated devices have been installed.

The profile includes the fan motor's RPM and driving signals, which are normally Pulse-Width-Modulation (PWM) signals or voltage signals, or frequency signals for an inverter driven motor fan. The indoor variable speed fan motor 42 RPM is proportional to the airflow volume under the same installation. Therefore, the air volume is proportional to the fan motor driving signal, e.g. a PWM signal. By controlling the fan motor PWM signal, it is possible to control the airflow volume of the air conditioning system. Assuming that the gas density is constant and impeller diameter is constant during the fan operation, according to accepted “fan law”, two given points of operation on the fan characteristic curve can be obtained as follows:

Q2/Q1=(N2/N1) (8)

P2/P1=(N2/N1)² (9)

W2/W1=(N2/N1)³ (10)

where,
Q2, Q1 are the airflow rates;
P2, P1 are the pressures (total, static or velocity);
W2, W1 are the impeller powers.

By testing the indoor variable speed fan motor 42 at constant airflow volume, one can obtain the indoor variable speed fan motor 42 profile curve RPM versus PWM at this constant airflow volume. When a zone damper 62 is closed, the indoor variable speed fan motor 42 would speed up and can be detected by measuring the fan's RPM. Therefore, indoor controller 47 can reduce the fan drive signal PWM to keep the RPM lower. According to the fan profile curve, a certain PWM signal should produce a pre-defined RPM. Until the indoor controller 47 obtains this next operation point, the indoor controller 47 keeps reducing the PWM signal and measuring the fan's RPM. Once the balanced operation point is found, the indoor controller 47 can stop searching for a next operation point. This new operation point is the required working point that supplies a pre-defined air volume to the rest of the air conditioning system. Because fan speed has been reduced, the power saving has been achieved more significantly. According to “fan law”, it is estimated that a 10% reduction of fan speed saves about 27% of used power.

### Self Learn Mode

It is generally considered important to obtain a specific fan profile curve for a specific installation. By studying the fan motor under most application conditions, there is provided a way to achieve this goal by self-learning in the individual installation and creating an installation-specific indoor variable speed fan motor 42 profile curve. After the installation of the air conditioning system, an installer can enter into an indoor variable speed fan motor 42 setup mode. Then the indoor controller 47 gradually speeds up the indoor variable speed fan motor 42, up to its reference RPM (which is according to the fan's manufacture, say 1275 RPM), with all zones open, so that measurement and recordal of the fan's RPM and PWM can be obtained. This process can also check whether the system has high or low external static ductwork. If any error is found, an indication can be provided on the master thermostat display. If the limit test is passed, then the indoor controller 47 can record the fan speed and determine whether the installation has high static pressure for compensation or not. Then the indoor controller 47 can slow down the indoor variable speed fan motor 42, up to 10% PWM, and measure and record the fan's RPM. The last test is to close all the zones at 10% PWM signal, and measure and record the fan's RPM. Based on this recorded data, the indoor controller 47 can create a profile curve table. By using this profile curve, profile-based air volume control has been achieved.

### Manual Fan Speeds

A control method can be provided that also includes a function where the indoor variable speed fan motor 42 can have fan speeds manually selected by a user via the master thermostat 60. This can be of benefit when the user wishes to override the automatic control and boost more air into one zone.

The manually selectable speeds, for example three speeds may be provided, have a significant advantage over a standard Permanent Split Capacitor (PSC) AC induction fan motor fan, as shown in FIG. 2. The fan shown in FIG. 2 may be of single speed or multiple speeds. However, even in the case of multiple speeds the speed break between the highest and lowest speeds may be only up to 20%. This 20% would be under low static operation, if zones are closed the static pressure becomes much higher and then the speed breaks can be reduced to nearly 0%.

The fan motor blower 44 shown in FIG. 5 has greater speed breaks between its highest and lowest speeds, typically around 15% between each speed. More importantly, these speed breaks are maintained during high static operation when zones are closed. This is achieved by having a pre-defined RPM limit for each speed.

### Minimum Open Zone Damper Prevention

In the air conditioning system 90, the total fully open position of each zone damper 62 can be, for example, divided into 20 steps, or any other number. When the total open position of active zones is less than a pre-defined number, the indoor controller 47 can cycle off the variable capacity compressor 23 to save energy and prevent any unnecessary temperature over-shooting and operation mode swing (due to very low demand). Here we define total zone position as follows:

P=sum{P1, P2, . . . , Pn} (11)

where,
Pi=opening position of i-th active zone, value from 0 to 20;
i=1,2, . . . ,n active zone.

We conclude as follows:

a) The variable capacity compressor 23 cycles off if P<Pset;

b) The variable capacity compressor 23 stays on if P>Pset.

Preferably, the default value of Pset is around 2 to 4, or 1.5% to 3% of a totally open position. The user can also override the modulating zones dampers 62 by quickly double pressing the mode on/off button on an individual zone thermostat 65.

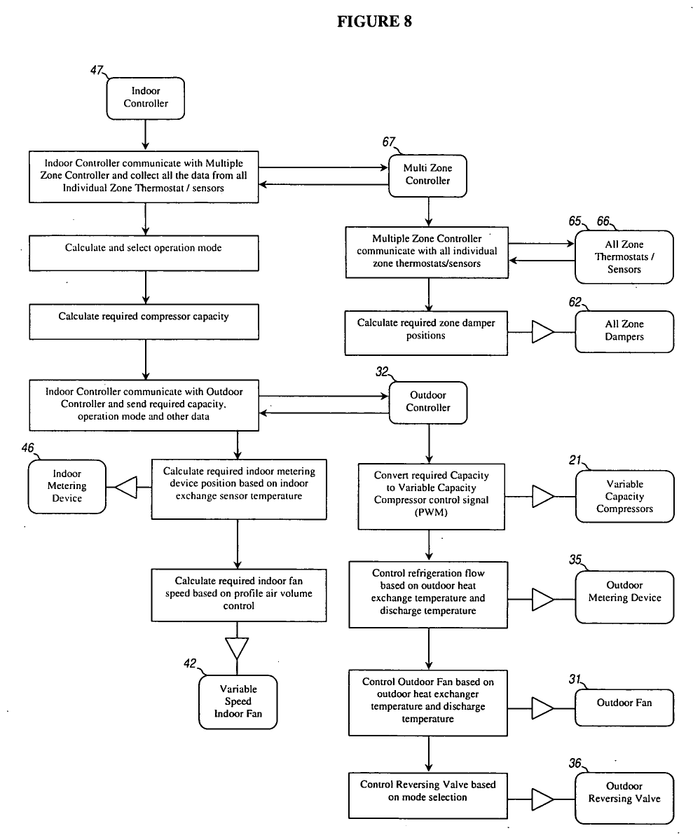

Referring to FIG. 8 there is illustrated a flow diagram of an example method of system control summarising previous steps.

Thus, in one form, there has been provided a method of control of an air conditioning system comprising an indoor controller that is able to receive commands from individual zone thermostats and give priority to a highest demand zone thermostat. This priority thermostat can directly proportionally control a variable capacity compressor via the indoor and outdoor controller.

In various other non-limiting forms, there is provided an indoor controller that looks at all zone thermostat differentials between a target temperature and a zone space temperature, at a pre-defined interval, and then assigns priority to an individual zone thermostat that has the greatest differential. The assigned zone thermostat can directly and proportionally control a variable capacity compressor via the indoor controller and the outdoor controller. A variable capacity compressor is given an initial start-up capacity by the indoor controller, based on the differential between the zone thermostat target temperature and zone space temperature. After a given time, the indoor controller can adjust the capacity percentage of the variable capacity compressor in finite steps, so as to help achieve and maintain the target temperature of the priority zone thermostat. A cooling or heating mode can be selected by comparing the cooling demand versus the heating demand of active zone thermostats, if compressor-running capacity is less than a pre-defined capacity value. A pre-defined capacity value is adjustable by the user via the master thermostat. Once the mode has been selected, it can preferably only be changed if the pre-defined compressor running timer has elapsed.

In further various other non-limiting forms, a pre-defined running timer is adjustable by the user via the master thermostat. If cooling and heating demand are the same, then the cooling or heating mode is selected by using the greatest zone thermostat differential. If the greatest zone differential is the same for cooling and heating, then the greatest number of cooling or heating zone thermostats requests determine the operating mode. If the numbers of cooling and heating zone thermostats requests are the same, then cooling is selected. The individual thermostats can only take priority if they have the greatest differential and are asking for the same operating mode as the current priority thermostat. The indoor controller monitors the indoor heat exchanger temperature sensor. The indoor heat exchanger temperature sensor is ignored unless the sensor temperature falls below a pre-defined value for cooling and rises above a pre-defined value for heating. If the indoor heat exchanger temperature falls below the pre-defined value for cooling or rises above the pre-defined value for heating, the indoor controller uses the indoor heat exchanger temperature as compressor capacity control and the zone thermostats no longer have priority. Priority can be a pre-defined heat exchanger target temperature for cooling or a pre-defined heat exchanger target temperature for heating. The pre-defined indoor heat exchanger temperature targets are adjustable by the user via the master thermostat for both heating and cooling in small increments. The indoor controller can give compressor capacity control priority, based on the lowest demand between the indoor heat exchanger temperature requirement or the greatest differential zone thermostat requirement. The modulating zone dampers can be opened or closed proportionally by the multiple zone controller, to achieve the target temperature of the corresponding zone, based on the temperature differential between the zone thermostat target temperature and the zone space temperature.

In yet further various other non-limiting forms, an individual zone controller can lock an associated zone damper in the fully open position by pressing a MODE/On/Off button twice in quick succession. Individual zone thermostats that are locked in the fully open position, no longer give temperature sensor feed back. If all zone thermostats are locked fully open, then a zone 1 temperature sensor is the only zone thermostat sensor that gives feedback to the indoor controller as the compressor capacity requirement. The indoor controller has an automatic control method of the indoor fan speed being set by a self-learning mode and a fan profile curve. When the user has selected an automatic mode at the master thermostat, the indoor fan then maintains a relatively constant supply air static pressure, whilst the individual zone dampers are modulating between opening and closing. The indoor controller senses a speed change in the indoor fan motor if the multiple zone controller modulates any of the zone dampers. The indoor controller, based on the self-learning fan profile curve, speeds up or slows down the indoor fan according to the dampers opening or closing respectively. The master thermostat has at least three manually selectable speeds, for example high, medium and low, the speeds offering approximately the same speed or airflow percentage break between the speed settings, regardless of the system static pressure. When the user selects the fan speed, the indoor controller controls the indoor fan at a pre-defined maximum RPM limit. A minimum open zone damper prevention method, such that when the total open position sum of active zones is less than a pre-defined number, the indoor controller cycles off the compressor to save energy and prevent long running periods of minimal airflow. The compressor can start again once a pre-defined compressor off timer has elapsed.

In yet further various other non-limiting forms, the self-learn mode learns the approximate external static pressure of the ductwork system with all zones open and then all zones closed. During the self learn mode, the indoor fan speed RPM preferably must fall within an operating RPM upper and lower limit. If the RPM is outside the limit, the master thermostat indicates this by flashing a LED. This fault indicates the ducting system is either too high or too low an external static pressure, respectively. The indoor controller has pre-defined maximum run period timers for when the compressor is operating below a pre-defined capacity percentage. The indoor controller has pre-defined minimum compressor capacity limits. The indoor controller has a minimum compressor capacity for heat only or cool only. The indoor controller has a minimum compressor capacity for automatic heat/cool. The minimum compressor capacity for automatic heat/cool is lower than heat or cool only.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

Forms of the present invention may take the form of an entirely hardware embodiment, an entirely software embodiment, firmware, or an embodiment combining software and hardware aspects.

1. A method of controlling an air conditioning system, the air conditioning system including a plurality of individual zone thermostats, an outdoor unit including a variable capacity compressor, and at least one controller, the method including the steps of:
receiving, at the at least one controller, signals from the plurality of individual zone thermostats;
determining a heating or cooling demand based on the signals; and, using the determined demand to control operation of the variable capacity compressor.

2. The method as claimed in claim 1, wherein the at least one controller obtains differential temperatures and a priority is allocated to a priority individual zone thermostat with the greatest differential temperature.

3. The method as claimed in claim 2, wherein a proportional signal corresponding to the greatest differential temperature is relayed to an outdoor controller for controlling the variable capacity compressor.

4. The method as claimed in claim 3, wherein the priority individual zone thermostat directly and proportionally controls output of the variable capacity compressor using the proportional signal.

5. The method as claimed in claim 4, wherein after a pre-selected time, the at least one controller adjusts a capacity percentage of the variable capacity compressor in finite steps to maintain a target temperature for the priority individual zone thermostat.

6. The method as claimed in claim 2, wherein if the greatest temperature differential for different zone thermostats is the same for a cooling demand and a heating demand, then the greatest number of cooling demands or heating demands from individual zone thermostats determines an operation mode of the variable capacity compressor.

7. The method as claimed in claim 2, wherein a different individual zone thermostat is allocated priority if the different individual zone thermostat has the greatest temperature differential and is requesting the same heating demand or cooling demand as the priority individual zone thermostat.

8. The method as claimed in claim 1, wherein the at least one controller monitors an indoor heat exchanger temperature sensor, which is ignored unless the temperature sensed from the indoor heat exchanger temperature sensor is outside a pre-defined range.

9. The method as claimed in claim 8, wherein if the indoor heat exchanger temperature falls below a pre-defined value for cooling or rises above a pre-defined value for heating, then the at least one controller uses the indoor heat exchanger temperature as basis for control of the variable capacity compressor.

10. The method as claimed in claim 2, wherein a zone damper is associated with an individual zone, and the zone damper is opened or closed by the controller based on the differential temperature for the individual zone.

11. The method as claimed in claim 10, wherein the at least one controller attempts to maintain an indoor variable speed fan at a constant supply air static pressure while individual zone dampers are opening or closing.

12. The method as claimed in claim 11, wherein a speed change is sensed in the indoor variable speed fan motor when the at least one controller modulates any of the individual zone dampers.

13. The method as claimed in claim 11, wherein the at least one controller uses a fan profile curve to speed up or slow down the indoor variable speed fan motor.

14. The method as claimed in claim 11, wherein when the total open position sum for zone dampers of active zones is less than a pre-defined number, the at least one controller cycles off the variable capacity compressor.

15. An air conditioning system for supplying conditioned air to a plurality of zones, each zone provided with an individual zone thermostat, each zone also provided with a zone damper, the system including at least one controller able to communicate with the individual zone thermostats and able to control operation of the zone dampers.

16. The air conditioning system as claimed in claim 15, further including a variable capacity compressor, the at least one controller also able to control operation of the variable capacity compressor.

17. The air conditioning system as claimed in claim 15, wherein the at least one controller directly and proportionally controls the variable capacity compressor using a greatest differential temperature obtained from the individual zone thermostats.

18. The air conditioning system as claimed in claim 15, including an indoor variable speed fan motor, the at least one controller also able to control operation of the indoor variable speed fan motor.

19. An air conditioning system for supplying conditioned air to a plurality of zones, including:
a plurality of individual zone thermostats;
a plurality of zone dampers;
an outdoor unit including a variable capacity compressor;
a multiple zone controller able to communicate with:
the plurality of individual zone thermostats;
the plurality of zone dampers; and,
the variable capacity compressor.

20. The air conditioning system as claimed in claim 19, including an indoor unit including a variable speed fan motor, the multiple zone controller influencing operation of the variable speed fan motor if the multiple zone controller modulates one or more of the zone dampers.
